(19) United States
(12) Patent Application Publication
(10) Pub. No.: US 2007/0057577 A1
(43) Pub. Date: Mar. 15, 2007

(54) Automotive audio-video equipment providing A.C. power

(76) Inventor: Claudio R. Laraia, Mohegan Lake, NY (US)

Correspondence Address: RICHARD C. CALDERWOOD, 2775 NW 126TH AVE, PORTLAND, OR, 97229-8381, US

(21) Appl. No.: 11/224,781

(22) Filed: Sep. 12, 2005

(51) Int. Cl. B60R 25/00

(52) U.S. Cl. 307/10.2

(57) ABSTRACT

For use in a vehicle, an in-dash or other d.c. powered audio-video component such as a head unit, DVD player, or the like, which has an a.c. electrical outlet located so as to be accessible to an occupant of the vehicle. The a.c. power is generated by a power inverter within the component, or is generated by an external power inverter and then passed through the component from a rear panel connector to a front panel connector. The component may also provide front panel audio-video connectors which are passed to through to rear panel connectors, or which are tied into the component's own circuitry.

### BACKGROUND OF THE INVENTION

1. Technical Field of the Invention

This invention relates generally to automotive audio-video systems, and more specifically to provision in a d.c. powered vehicle of a.c. electricity for a.c. powered equipment.

2. Background Art

FIG. 1 illustrates a vehicle equipped with conventional audio-video and electrical equipment.

Some electrical equipment is designed to operate on direct current (d.c.) electric power. Other electrical equipment is designed to operate on alternating current (a.c.) electric power. Virtually all automobiles and other vehicles operate on d.c. electric power. Automobiles intended for sale in the United States of America are designed to use 12 vdc electrical systems, with a +12 vdc power rail and a 0 vdc or ground power rail. Motorcycles intended for sale in the United States of America are designed to use 6 vdc electrical systems, with a +6 vdc power rail and a 0 vdc or ground power rail. Other vehicles use a +24 vdc system, or a −12 vdc system, or what have you. The “hot” or non-ground power rail is provided throughout the vehicle by a wiring harness. Some portions of the vehicle's electrical system may use the wiring harness for providing the ground rail, while other portions may use the vehicle's frame and chassis for providing the ground rail.

The vehicle's internal combustion engine is typically coupled to drive an alternator or a generator, which provides the electrical power to the wiring harness. In most vehicles, the alternator charges a storage battery, such as a lead-acid battery, which is coupled to power the wiring harness. Electrical equipment is coupled to the wiring harness throughout the vehicle, and may include, for example, lights, gauges, engine and anti-lock brake control computers, and so forth, as well as a variety of audio-video equipment such as a radio, a CD player, a DVD player, an in-car PC, a media player, and the like, with their attendant input and output devices such as loudspeakers and display screens. These audio-video devices are designed to operate using d.c. electrical power.

Some audio-video components are mounted in the vehicle's dashboard. These typically include the stereo system's head unit which includes the radio tuner, amplifier, cassette tape player, single-disc CD player, and so forth. They may also include an auxiliary unit such as an external (to the head unit) CD player or CD changer. Other audio-video components are mounted elsewhere in the vehicle. These may include, for example, a VCR mounted under the rear seat with its controls facing forward for easy access by the rear seat passengers, or an in-car PC, or a media player, or what have you.

In addition to the d.c. powered devices, a vehicle may include a variety of devices which are designed to operate using a.c. electrical power. For example, the vehicle's driver may wish to charge her laptop computer while driving, using a conventional 110 vac power adaptor. Or, her children may wish to play video games on the vehicle's built-in flip-down video monitor and built-in stereo system, using a video game console such as an Xbox, Nintendo, Sony Playstation, or the like, which is designed to be powered by the 110 vac power of a residential home electrical system.

Power inverters are available for converting e.g. 12 vdc into 110 vac electric power, enabling these a.c. powered devices to be used in a d.c. powered vehicle. Removable power inverters are typically connected to the vehicle's d.c. wiring harness via a cigarette lighter plug. In some vehicles, a power inverter is permanently installed e.g. under the hood or under the dashboard.

In addition to the electrical power connection, some audio-video devices provide audio and/or video signals which need to be routed into the audio-video system of the vehicle. In order to facilitate the connection of both the a.c. power cord and the audio-video cables, some vehicles have been fitted with an aftermarket “game plate” which provides a common connection point for both, and which gives the vehicle a “clean” aesthetic appearance when the a.c. powered equipment is not connected. The game plate is usually used in conjunction with a permanently installed power inverter. With the game plate mounted in an easily accessible location, the installation location of the power inverter becomes much less important, and does not need to be as easily accessible.

The game plate is typically mounted in a location which is readily accessible to the person who will be operating, or at least installing, the a.c. powered equipment. For example, the game plate may be mounted on the rear-facing surface of a center console between the front seats, for easy access by a rear passenger. Or, it may be mounted in the dashboard for easy access by a front passenger.

Regardless of where the game plate is mounted, the back side of its power outlet is permanently cabled to the output of the power inverter, and the back sides of its audio-video connectors are permanently cabled to the vehicle's audio-video system. To use an a.c. powered audio-video component such as a game unit, the user simply plugs its a.c. power cord into the game plate's a.c. outlet, and plugs its audio-video cables into the game plate's audio-video connectors. The users can then operate the a.c. powered game unit, with its input and output devices such as game controllers.

Although this existing technology works, the game plate takes space, and installing the game plate costs time and money.

What is desirable, then, is a system for providing a.c. power to audio-video or other a.c. powered equipment in a vehicle without the use of a game plate.

### BRIEF DESCRIPTION OF THE DRAWINGS

FIG. 1 shows a d.c. powered vehicle equipped with a game plate for providing a.c. power to audio-video equipment, according to the prior art.

FIG. 2 shows a d.c. powered vehicle equipped with a pass-through head unit which provides a.c. power, according to one embodiment of this invention.

FIG. 3 shows a d.c. powered vehicle equipped with a power inverting head unit which provides a.c. power, according to another embodiment of this invention.

FIG. 4 shows a d.c. powered vehicle equipped with a pass-through audio-video component which provides a.c. power, according to another embodiment of this invention.

FIG. 5 shows a conventional head unit in front perspective view.

FIG. 6 shows the conventional head unit in rear perspective view.

FIG. 7 shows a pass-through head unit of the present invention in front perspective view.

FIG. 8 shows the pass-through head unit in rear perspective view.

FIG. 9 shows a power inverting head unit of the present invention in rear perspective view.

FIG. 10 shows a pass-through auxiliary unit in front perspective view.

FIG. 11 shows the pass-through auxiliary unit in rear perspective view.

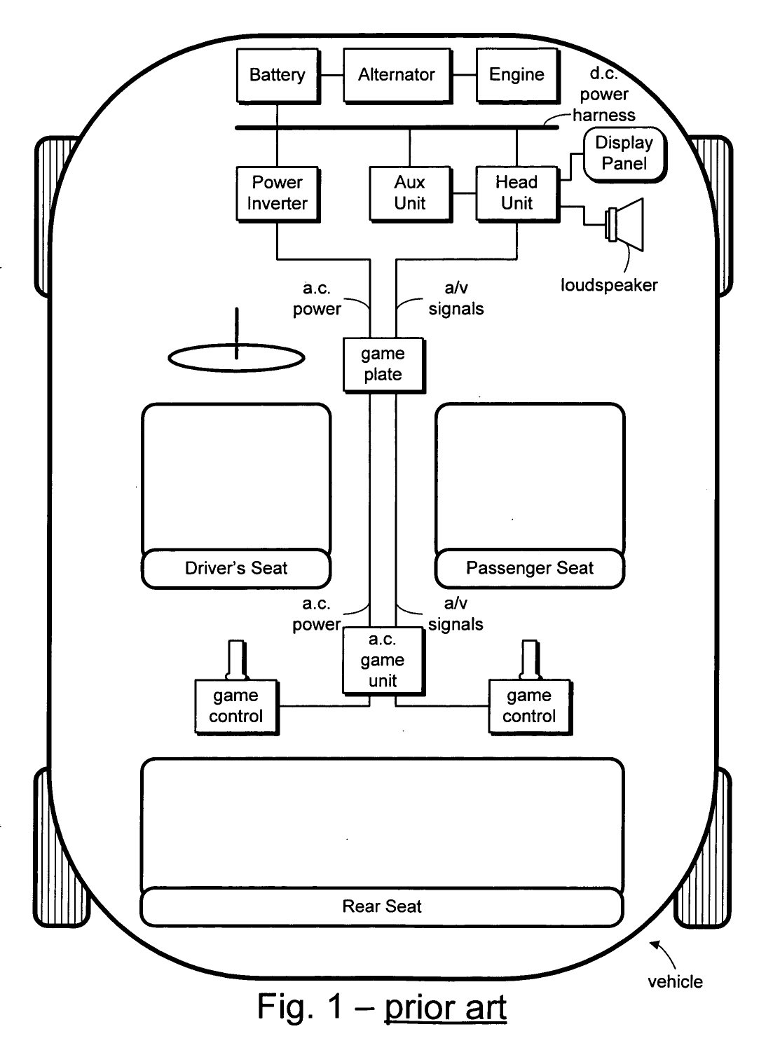

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

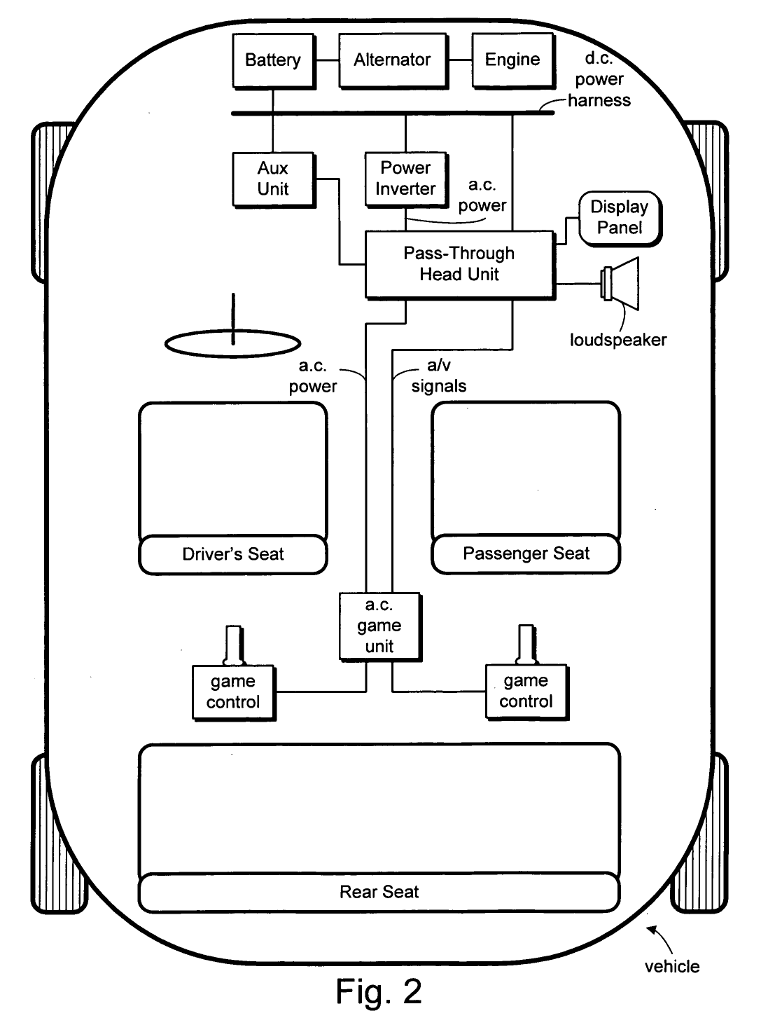

FIG. 2 illustrates a vehicle equipped with a pass-through head unit according to one embodiment of this invention. The head unit is powered by the vehicle's d.c. power harness. A power inverter is also coupled to the d.c. power harness and provides a.c. electrical power to the head unit. The head unit passes the a.c. electrical power out (as will be explained below) for use by a.c. powered equipment within the vehicle, such as a game unit. The head unit may optionally also provide connection (as will be explained below) for audio-video signal connections for the a.c. powered equipment.

In one embodiment, the head unit passes video signal(s) from the game unit through to a video display panel, and passes audio signal(s) from the game unit through, typically via the amplifier section of the head unit, to one or more loudspeakers mounted in the vehicle. The audio signals may alternatively be routed to e.g. wireless headphone transmitter(s) or to wired headphone jack(s).

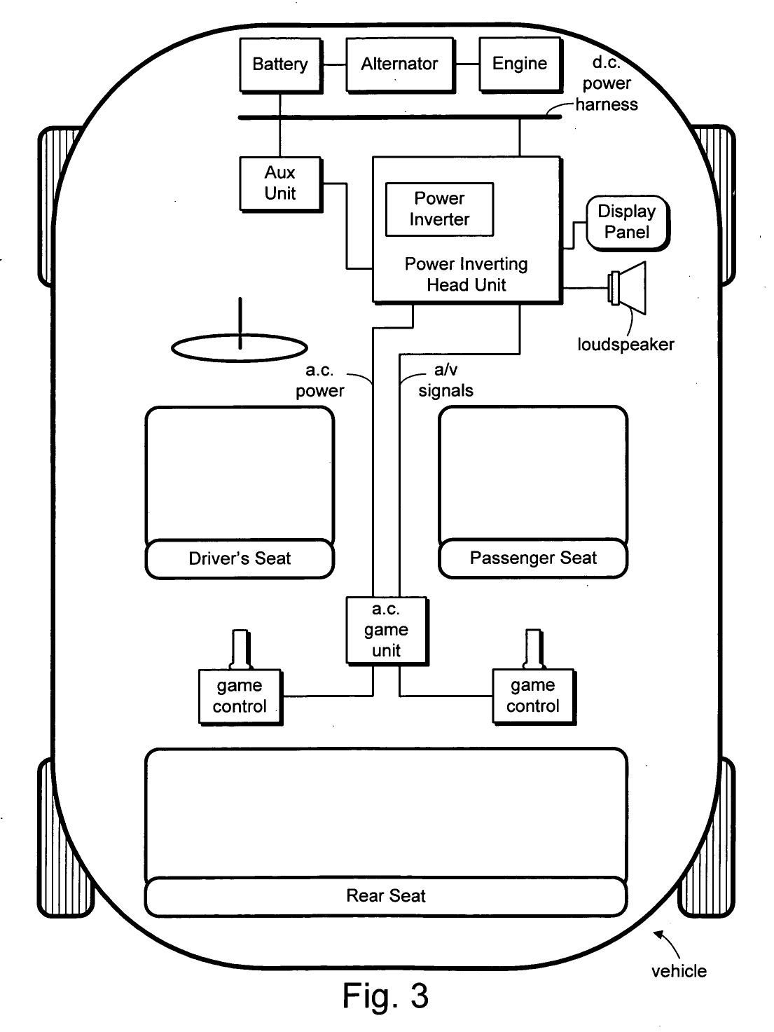

FIG. 3 illustrates a vehicle equipped with a power inverting head unit according to another embodiment of this invention. The head unit is coupled to the d.c. power harness, and includes an internal power inverter.

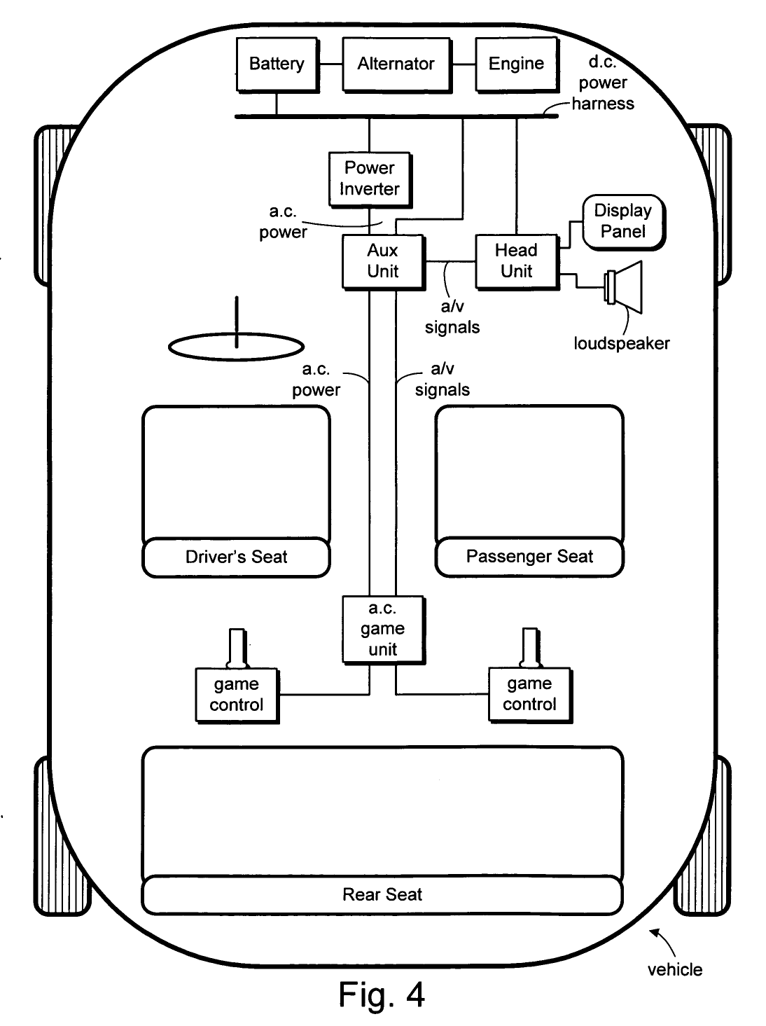

FIG. 4 illustrates a vehicle equipped with a pass-through auxiliary audio-video component which is not a head unit. It may be, for example, a CD player, a DVD player, a cassette tape player, an iPod docking station, or what have you. The head unit and the auxiliary component are powered by the vehicle's d.c. power harness. A power inverter is coupled to the d.c. power harness and provides a.c. power. The auxiliary component is coupled to the a.c. output of the power inverter, and passes the a.c. power out (as will be explained below) for use by the game unit.

The auxiliary unit further includes audio-video connectors to which the game unit is connected, and passes these signals through to the head unit and/or video display etc.

In another embodiment, the audio-video connection may be directly from the game unit to the head unit, such that the game unit's a.c. power cord is plugged in to the auxiliary unit and its audio-video cables are plugged in to the head unit.

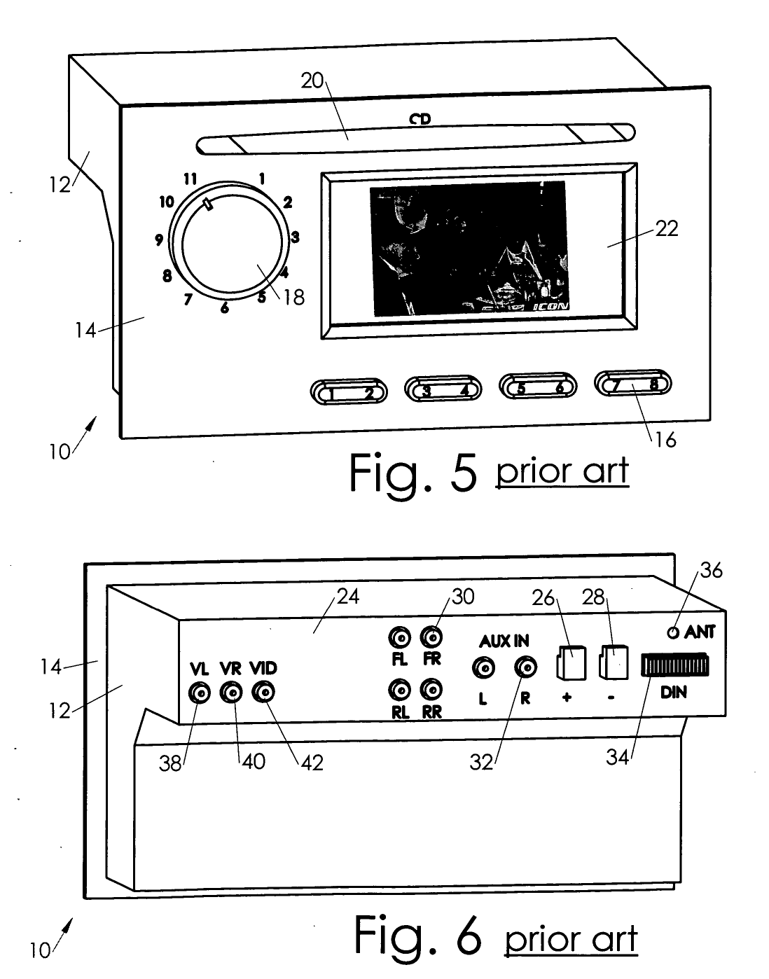

FIG. 5 illustrates a double-DIN head unit 10 according to the prior art. The head unit includes a body 12 having a front plate 14. The front plate is equipped with controls 16, 18 accessible from the passenger compartment of the vehicle. The head unit may include a variety of optional features, such as a built-in CD player 20, a video display 22, and so forth.

FIG. 6 illustrates the rear of the head unit 10. The body includes a rear panel 24 which is equipped with a variety of electrical cable connectors. It typically includes a “+” d.c. electrical power connector which is coupled to the hot wire of the vehicle's wiring harness and a “−” or ground power connector which is coupled to the ground wire of the vehicle's wiring harness. It typically includes a plurality of audio signal output connectors 30, which may carry pre-amp or post-amp level signals. It may also have one or more auxiliary input signal connectors 32, 34, and a radio antenna connector 36.

It may further include a plurality of audio-video output signal connectors, such as an audio left channel connector 38, an audio right channel connector 40, and a composite video connector 42.

These are only illustrative or exemplary audio-video signal connectors, and are not intended to be an all-encompassing list. The connectors may vary significantly from device to device.

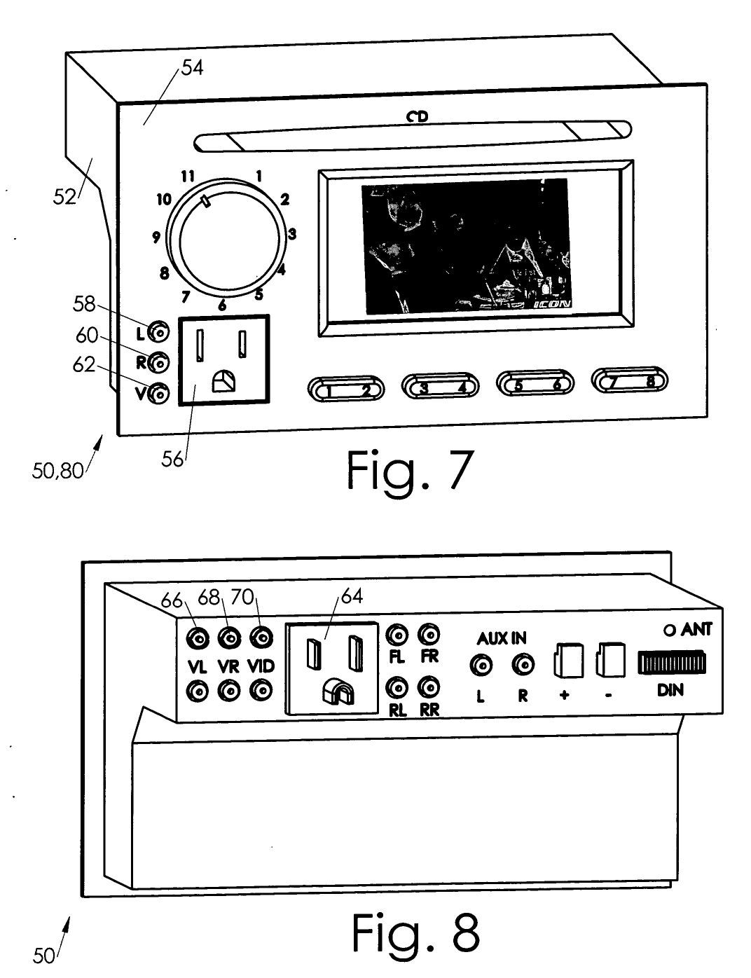

FIG. 7 illustrates a pass-through head unit 50 according to one embodiment of this invention. The head unit includes a body having a face plate 54. In addition to the usual controls and displays etc., the face plate is equipped with an a.c. power outlet 56 or connector. The a.c. power outlet is of a form factor suitable for use with the intended a.c. powered equipment to be used in the vehicle. In one embodiment, the a.c. power outlet is a USA standard 2- or 3-prong 110 vac female socket.

The face plate further includes one or more audio-video input signal connectors. In one embodiment, these include a left audio channel connector 58, a right audio channel connector 60, and a composite video connector 62. The audio-video output cables of the game unit are plugged into these connectors. In one embodiment, these connectors are standard RCA female connectors.

FIG. 8 illustrates the rear of the pass-through head unit 50. In addition to the usual power and signal connectors, the head unit is equipped with an a.c. power inlet 64 or connector. The a.c. power inlet is of a form factor suitable for mating with the a.c. outlet of the power converter or an intervening power cord. In one embodiment, the a.c. power inlet is a USA standard 2- or 3-prong 110 vac male plug. The a.c. power inlet on the rear is connected to the a.c. power outlet on the face plate of the head unit, to pass the a.c. power from the power inverter through to the game unit.

The rear further includes one or more audio-video signal connectors which are connected to corresponding ones of the face plate audio-video connectors, and may thus include a left audio channel connector 66, a right audio channel connector 68, and a composite video connector 70. These connectors are of form factor(s) suitable for use with the cabling that connects them to their intended destinations. In one embodiment, these connectors are standard RCA male connectors.

In another embodiment, the face plate audio signals are routed into the stereo electronics of the head unit, and only the composite video signal is passed through from the face plate connector to the rear connector (from where it can be cabled directly to the display panel).

In some embodiments, the video output connector is fed not only by the face plate video input connector, but also by another video source e.g. a DVD player which may be internal to the head unit or may itself be an auxiliary unit. In such implementations, it will typically be desirable to provide a suitable switching control within the head unit, so that only one source's signal is fed to the rear panel video connector at a time. This switching may be automatic according to some detection and priority scheme, or it may be manually controlled by the user.

FIG. 7 may further be understood to illustrate a power inverting head unit 80, in which the a.c. power is generated within the head unit, rather than being passed through.

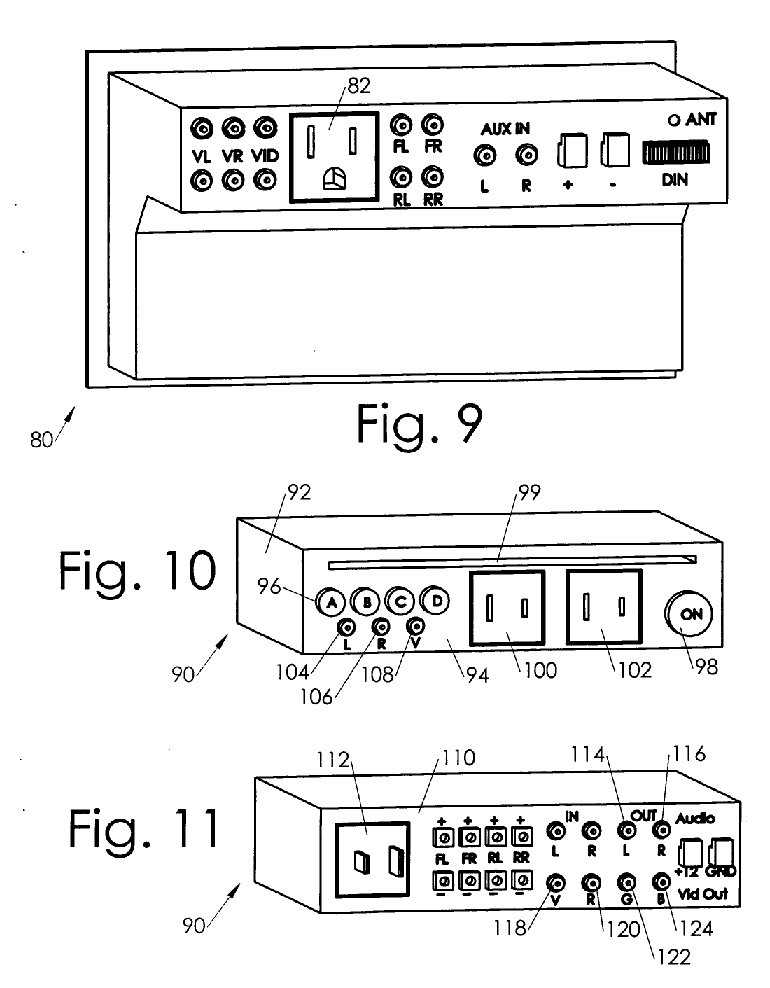

FIG. 9 illustrates the rear of the power inverting head unit 80. In addition to the pass-through audio-video connectors on the face plate and rear panel, the head unit may include one or more a.c. power outlets 82 on its rear panel. Additional, permanently installed a.c. powered equipment may be plugged into these rear outlets, leaving the face plate a.c. outlet free for use with a game unit or other removable equipment.

FIG. 10 illustrates a pass-through auxiliary component 90 according to yet another embodiment of this invention. The pass-through auxiliary component may be used in lieu of, or in addition to, the pass-through head unit or the power inverting head unit. It includes a body 92 with a front panel 94. The front panel includes any variety of controls 96, 98, and other features, such as a slot 99 for inserting a DVD or CD. The front panel further includes an a.c. power outlet 100. Optionally, it may also include a second a.c. power outlet 102. And optionally, it may further include one or more audio-video inputs for use with a game unit, such as a left audio channel connector 104, a right audio channel connector 106, and a composite video connector 108.

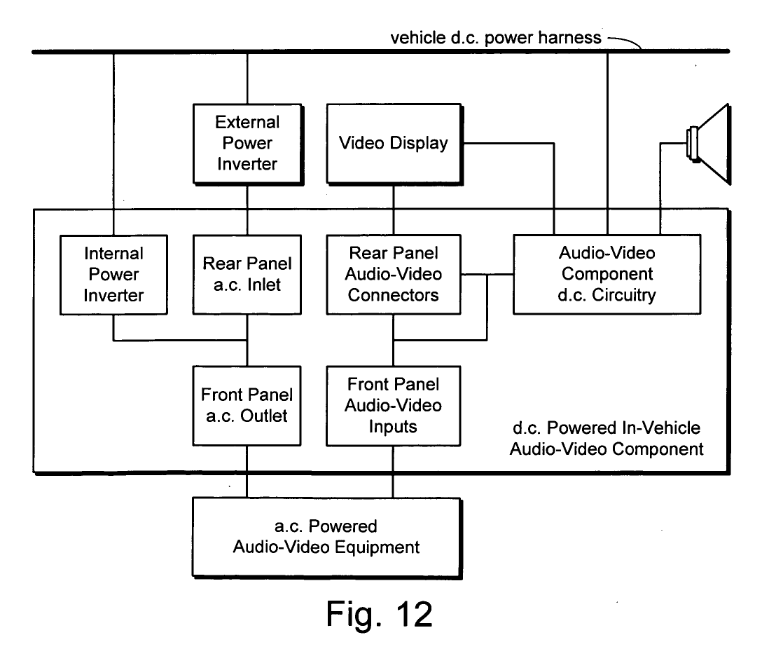

FIG. 11 illustrates the rear of the pass-through auxiliary component 90. A rear panel 110 includes an a.c. power connector 112 suitable for connecting to a power inverter and cabled through to the a.c. power outlet(s) on the front panel.

In addition to a conventional complement of signal connectors, it optionally also includes one or more audio-video connectors for passing through the signals from the front panel connectors. For example, it may include a left audio channel connector 114, a right audio channel connector 116, and a composite video connector 118. In some embodiments, the auxiliary component may perform some type of processing of the signals arriving on the front panel connectors, before passing them through to their corresponding rear panel connectors. For example, video circuitry (not shown) inside the DVD player may convert a front panel composite video input signal into e.g. an RGB video output signal at a red video connector 120, a green video connector 122, and a blue video connector 124.

FIGS. 10 and 11 may alternatively be understood to represent a component which is adapted for e.g. under-seat mounting, rather than an industry standard form factor in-dash component.

FIG. 12 illustrates the d.c. powered in-vehicle audio-video component, whether it be a head unit or an auxiliary unit. The component includes d.c. powered circuitry (“Audio-Video Component d.c. Circuitry”) such as radio circuits, amplifier circuits, CD player circuits, or what have you, which is powered from the vehicle's d.c. power harness. The component is coupled to whatever audio-video output devices are suitable, such as loudspeakers and a video display. This much is conventional.

As concerning the invention, the component includes at least one front panel a.c. outlet for providing a.c. electric power to an a.c. powered equipment such as an audio-video equipment. The a.c. power is provided to this front panel a.c. outlet from an internal power inverter coupled to the vehicle's d.c. power harness, and/or from a rear panel a.c. inlet which in turn receives it from an external power inverter which derives its power from the vehicle's d.c. power harness.

And further as optionally concerning the invention, the component includes at least one front panel audio-video input connector for receiving at least one audio-video signal from the a.c. powered audio-video equipment. The audio-video signals received at the front panel inputs are routed to suitable destinations. For example, audio signals may be routed directly to the component's d.c. circuitry, as in the case where the component is a head unit. Or, the audio signals may be routed to rear panel audio-video connectors, from which they may be routed to e.g. an external amplifier (not shown). And for example, video signals may be routed directly to the component's d.c. circuitry, such as for video processing, after which they will be sent to a video display unit. Or, the video signals may be routed to the rear panel audio-video connectors, and from there to the video display or to e.g. an external video switch or DVD player (not shown).

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

The specific voltages and the specific connectors described and shown are for illustration only, and are not limiting of the scope of the invention.

In some applications, it may be desirable to provide the a.c. power outlet on e.g. a side panel of a d.c. powered audio-video component whose side panel is suitably accessible to occupants of the vehicle, such as a dash-top mounted CB radio. The terms “front panel” and “face plate” are intended to include such locations, and are simply meant to distinguish from surfaces which are very inaccessible such as those facing inside the dashboard.

The term “audio-video” is intended to signify a component or a signal which is audio and/or video, and not solely the combination of both audio and video. For example, a radio is an audio-video component, even though it lacks video.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An audio-video apparatus for use in a vehicle having a d.c. electrical system and for powering an a.c. equipment, the apparatus comprising:
d.c. audio-video circuitry adapted for being powered by the vehicle's d.c. electrical system;
a front panel accessible to an occupant of the vehicle;
an a.c. power outlet coupled at the front panel so as to be accessible to the occupant; and
means, coupled to the a.c. power outlet, for providing a.c. electrical power to the a.c. power outlet, the a.c. electrical power being inverted from the vehicle's d.c. electrical system.

2. The audio-video apparatus of claim 1 wherein the means for providing a.c. electrical power comprises:
a rear panel a.c. inlet adapted for being coupled to an external power inverter, and coupled to pass the a.c. electrical power from the external power inverter through to the a.c. power outlet.

3. The audio-video apparatus of claim 1 wherein the means for providing a.c. electrical power comprises:
an internal power inverter having an a.c. output coupled to the a.c. power outlet.

4. The audio-video apparatus of claim 1 wherein:
the a.c. power outlet comprises a US standard 110 vac outlet.

5. The audio-video apparatus of claim 4 wherein:
the 110 vac outlet comprises a 2-prong outlet.

6. The audio-video apparatus of claim 4 wherein:
the 110 vac outlet comprises a 3-prong outlet.

7. The audio-video apparatus of claim 1 wherein:
the audio-video apparatus comprises a head unit.

8. The audio-video apparatus of claim 1 wherein:
the audio-video apparatus comprises an auxiliary unit adapted for coupling to a head unit.

9. The audio-video apparatus of claim 1 further comprising:
at least one audio-video input connector coupled to the front panel for coupling to a corresponding at least one audio-video output of the a.c. equipment.

10. The audio-video apparatus of claim 9 wherein the at least one audio-video input connector comprises:
a left audio channel connector;
a right audio channel connector; and
a composite video connector.

11. The audio-video apparatus of claim 10 wherein the at least one audio-video connector comprises:
female RCA connectors.

12. The audio-video apparatus of claim 9 wherein:
the at least one audio-video input connector is coupled to the d.c. audio-video circuitry.

13. The audio-video apparatus of claim 9 further comprising:
at least one rear panel audio-video output connector; and wherein the at least one audio-video input connector is coupled to the at least one rear panel audio-video output connector.

14. An improvement in an in-dash audio-video component for use in a vehicle having a d.c. electrical system, wherein the improvement comprises:
an a.c. electrical outlet disposed at a first surface of the in-dash audio-video component readily accessible to an occupant of the vehicle during normal operation of the vehicle; and
means for providing a.c. electrical power to the a.c. electrical outlet.

15. The improvement of claim 14 in the audio-video component, wherein the improvement further comprises:
the means for providing a.c. electrical power comprising an a.c. power inlet disposed at a second surface of the in-dash audio-video component not readily accessible to the occupant during normal operation of the vehicle, wherein the a.c. power inlet is coupled to the a.c. electrical outlet in a pass-through manner.

16. The improvement of claim 14 in the audio-video component, wherein the improvement further comprises:
the means for providing a.c. electrical power comprising an internal power inverter coupled to receive d.c. electrical power from the vehicle's d.c. electrical system, and having an a.c. output coupled to the a.c. electrical outlet.

17. The improvement of claim 14 in the audio-video component, wherein the improvement further comprises:
at least one audio-video signal input connector disposed at the first surface, whereby the occupant may plug an a.c. power cable of an a.c. powered audio-video equipment into the a.c. electrical outlet and at least one audio-video cable of the audio-video equipment into the audio-video signal input connector and thereby use the a.c. powered audio-video equipment in the vehicle including providing audio-video signals from the a.c. powered audio-video equipment to audio-video output devices of the vehicle via the in-dash audio-video component.

18. The improvement of claim 14 in the audio-video component, wherein the improvement further comprises:
the audio-video component comprises a head unit.

19. The improvement of claim 14 in the audio-video component, wherein the improvement further comprises:
the audio-video component comprises an auxiliary unit adapted for use with a head unit.

20. The improvement of claim 14 in the audio-video component, wherein the improvement further comprises:
the a.c. electrical power comprising substantially 110 vac 60 Hz electricity.
